(19) United States
(12) Patent Application Publication
(10) Pub. No.: US 2022/0092446 A1
(43) Pub. Date: Mar. 24, 2022

(54) RECOMMENDATION METHOD, COMPUTING DEVICE AND STORAGE MEDIUM

(71) Applicant: BOE Technology Group Co., Ltd., Beijing (CN)

(72) Inventors: Jinxiao WEN, Beijing (CN); Xibo ZHOU, Beijing (CN)

(73) Assignee: BOE Technology Group Co., Ltd., Beijing (CN)

(21) Appl. No.: 17/334,663

(22) Filed: May 28, 2021

(30) Foreign Application Priority Data
Sep. 22, 2020 (CN) 202010999112.8

(51) Int. Cl. G06N 5/04; G06F 16/215

(52) U.S. Cl. CPC G06N 5/04; G06F 16/215

(57) ABSTRACT

The present disclosure discloses a recommendation method, computing device, and storage medium. An implementation of the method includes: acquiring user operation data from a first terminal; invoking at least one recommendation algorithm in response to the user operation data to calculate at least one first recommendation result; displaying user information and an algorithm identifier of the invoked recommendation algorithm on a display apparatus of the computer device or a second terminal; displaying first recommendation result information calculated by a corresponding recommendation algorithm on the display apparatus of the computer device or the second terminal in response to an operation on the algorithm identifier.

### CROSS-REFERENCE TO RELATED APPLICATIONS

This application claims priority to Chinese Patent Application No. 202010999112.8, filed on Sep. 22, 2020, the disclosure of which is incorporated herein by reference in its entirety.

### TECHNICAL FIELD

This application relates to the field of Internet technology. More specifically, it relates to a recommendation method, a computing device, and a storage medium.

### BACKGROUND

With the development of the Internet, the number of users using the Internet has increased rapidly, and the number of Internet websites that provide users with content services has also increased. In order to better operate Internet websites and serve users of Internet websites, personalized information (content) recommendation systems based on user preferences came into being.

### SUMMARY

The present disclosure provides, a computing device, a method and a storage medium.

The first aspect of this disclosure provides a computing device. The computing device may include a processor; and a memory for storing processor executable instructions. The processor may be configured to: acquire user operation data from a first terminal; invoke at least one recommendation algorithm in response to the user operation data to calculate at least one first recommendation result; display an algorithm identifier of the invoked recommendation algorithm on a display apparatus of the computer device or a second terminal, and display first recommendation result information calculated by a corresponding recommendation algorithm on the display apparatus of the computer device or the second terminal in response to an operation on the algorithm identifier.

The second aspect of this disclosure provides a method. The method may include acquiring user operation data from a first terminal; invoking at least one recommendation algorithm in response to the user operation data to calculate at least one first recommendation result; displaying an algorithm identifier of the invoked recommendation algorithm on a display apparatus of the computer device or a second terminal; displaying first recommendation result information calculated by a corresponding recommendation algorithm on the display apparatus of the computer device or the second terminal in response to an operation on the algorithm identifier.

The third aspect of this disclosure provides a computer-readable storage medium with a computer program stored thereon. the program implements a method when executed by a processor, wherein the method is applied to a computer device and comprises acquiring user operation data from a first terminal; invoking at least one recommendation algorithm in response to the user operation data to calculate at least one first recommendation result; displaying an algorithm identifier of the invoked recommendation algorithm on a display apparatus of the computer device or a second terminal; displaying first recommendation result information calculated by a corresponding recommendation algorithm on the display apparatus of the computer device or the second terminal in response to an operation on the algorithm identifier.

It is to be understood that the above general descriptions and detailed descriptions below are only exemplary and explanatory and not intended to limit the present disclosure.

### BRIEF DESCRIPTION OF THE DRAWINGS

The specific implementation of the present disclosure will be described in further detail below in conjunction with the accompanying drawings.

FIG. 1 shows an exemplary system architecture diagram in which an example of the present disclosure can be applied.

FIG. 2 shows a flowchart of a recommendation method in an example of the present disclosure.

FIG. 3 shows a business flowchart of a recommendation method in an example of the present disclosure.

FIG. 4 shows a schematic diagram of a directed acyclic graph in an example of the present disclosure.

FIG. 5 shows a schematic structural diagram of a computer device according to an example of the present disclosure.

FIG. 6 shows a schematic structural diagram of a computer system that implements a computer device provided by an example of the present disclosure.

### DETAILED DESCRIPTION

In order to explain the application more clearly, the application will be further described below in conjunction with examples and drawings. Similar components in the drawings are denoted by the same reference numerals. Those skilled in the art should understand that the content described below is illustrative rather than restrictive, and should not be used to limit the protection scope of this application.

It should be noted that in the description of this application, relational terms such as first and second are only used to distinguish one entity or operation from another entity or operation, and do not necessarily require or imply there is any such actual relationship or sequence between these entities or operations. Moreover, the terms “including”, “including” or any other variants thereof are intended to cover non-exclusive inclusion, so that a process, method, article or device including a series of elements not only includes those elements, but also includes other elements that are not explicitly listed, or also includes elements inherent to this process, method, article or device. If there are no more restrictions, the element defined by the sentence “including a . . . ” does not exclude the existence of other identical elements in the process, method, article, or device that includes the element.

The results recommended by some systems are often dependent on a specific product, and most of the recommendation results are only displayed on the user's interactive interface (i.e., the user's electronic device). This display manner makes the recommendation system similar to a black box. The operator has no way of knowing user characteristics and behavior attributes that the recommendation result based on, and it is also difficult to perceive the recommendation logic and strategy in the recommendation system, so it is difficult to explain the reason for the recommendation result.

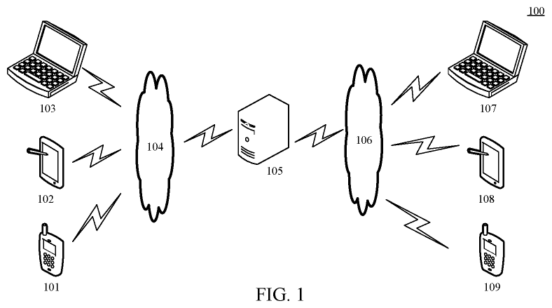

FIG. 1 shows an exemplary system architecture 100 to which an example of the recommendation method of the present disclosure can be applied.

As shown in FIG. 1, the system architecture 100 includes first terminal devices 101, 102, 103, a network 104, a server 105, a network 106 and second terminal devices 107, 108, 109. The network 104 is used to provide media of communication links between the first terminal devices 101, 102, 103 and the server 105, and the network 104 can include various connection types, such as wired, wireless communication links, optical fiber cables, and 5G networks, or the like. The network 106 is used to provide media of communication links between the server 105 and the second terminal devices 107, 108, 109, and the network 106 can include various connection types, such as wired, wireless communication links, optical fiber cables, and 5G networks, or the like.

The user can use the first terminal devices 101, 102, 103 to interact with the server 105 through the network 104, to receive or send messages. Various communication client applications, such as image recognition applications, web browser applications, shopping applications, search applications, instant messaging tools, email clients, and social platform software or the like may be installed on the terminal devices 101, 102, and 103.

The first terminal devices 101, 102, 103 and the second terminal devices 107, 108, 109 may be hardware or software. When the first terminal devices 101, 102, 103 and the second terminal devices 107, 108, 109 are hardware, they can be various electronic devices that have a display screen and support image recognition, including but not limited to smart phones, tablet computers, and laptops computers and desktop computers, or the like. When the first terminal devices 101, 102, 103 and the second terminal devices 107, 108, 109 are software, they can be installed in the electronic devices listed above. It can be implemented as a plurality of software or software modules (for example, to provide distributed services), or implemented as a single software module or software. There is no specific limitation herein.

The server 105 may be a server that provides various services. In an example, the server 105 is a data server loaded with a recall result database. The recall result database invokes the corresponding recall algorithm for calculation based on historical behavior data of the user, so as to obtain different calculation results, and save the calculation results in the recall result database.

In an example, the server 105 may be a server that provides various services, such as a back-end server that provides support for e-commerce applications on the first terminal devices 101, 102, and 103. The back-end server may invoke at least one recommendation algorithm based on the operating data from the first terminal device to generate at least one first recommendation result. The user information and the algorithm identifier of the invoked recommendation algorithm are displayed on the second terminal or the back-end server provided with the display apparatus, and the first recommendation result information is displayed.

It should be noted that the recommendation method provided by the example of the present disclosure is generally executed by the server 105, and correspondingly, the computer device used for the recommendation method is generally set in the server 105.

It should be noted that the server 105 may be hardware or software. When the server 105 is hardware, it can be implemented as a distributed server cluster composed of a plurality of servers, or as a single server. When the server 105 is software, it can be implemented as a plurality of software or software modules (for example, to provide distributed services), or implemented as a single software module or software. There is no specific limitation herein.

It should be understood that the numbers of the first terminal device, the network, the server and the second terminal device in FIG. 1 are merely illustrative. There can be any suitable number of terminal devices, networks, and servers as needed.

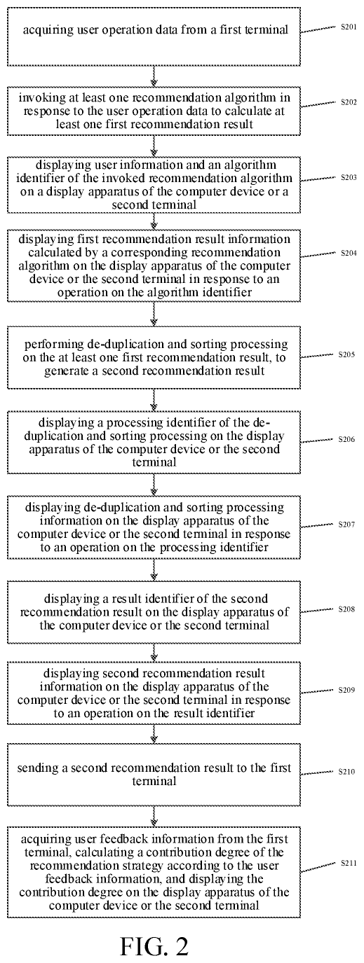

Please continue to refer to FIG. 2, which shows a flowchart of an example of a recommendation method applied to a computer device according to the present disclosure, which may include the following steps.

S201, user operation data from a first terminal is acquired.

In an example, the execution subject of the recommendation method used in this example (for example, the server 105 shown in FIG. 1) may obtain the user operation data from the first terminal locally or remotely through the network 104. In an example where the object of a recommendation method is commodity or service, the user operation data may include the user clicking, purchasing, browsing, forwarding, or sharing the commodity or service on the e-commerce application of the first terminal (for example, the user's electronic device).

S202, in response to the user operation data, at least one recommendation algorithm is invoked to calculate at least one first recommendation result.

In an example, the recommendation result is ID of the commodity calculated according to the recommendation algorithm. The execution subject of the recommendation method used in this example (for example, the server 105 shown in FIG. 1) is provided with a recall result database. The recall result database offline invokes at least one corresponding recall algorithm for the user's historical behavior data in advance to perform offline calculations, to obtain different offline calculation results, and saves the different offline calculation results in the recall result database for the recommendation algorithm to calculate to obtain at least one first recommendation result. By setting up the recall result database and analyzing historical behavior data of the user, the accuracy of the recommendation method can be improved.

In an example, the recall result database uses the in-memory computing framework Spark to perform offline recall operations, which can further improve computing efficiency. In another example, the algorithms included in the recall result database include: user-based collaborative filtering algorithm (User-CF), item-based collaborative filtering algorithm (Item-CF), user-based collaborative filtering algorithm considering time context factors (time-User-CF), item-based collaborative filtering algorithm considering time context factors (time-Item-CF), ALS algorithm, Word2vec algorithm and matrix factorization algorithm.

In an example, the execution subject of the recommendation method used in this example (for example, the server 105 shown in FIG. 1) responds to the user operation data, combines offline calculation results stored in the recall result database and user operation data, and invokes at least one recommendation algorithm to calculate at least one first recommendation result. The recommendation algorithm may include LGBM (Light GBM)+LR (Logistic Regression) algorithm, DNN (Deep Neural Networks) model, DeepFM model (generated by the combination of FM (Factorization Machine) model and DNN model), association rule algorithm and sorting algorithm. The above-mentioned various recommendation algorithms can use the offline calculation results in the recall result database to calculate the first recommendation result, and the first recommendation result is correspondingly obtained.

S203, user information and an algorithm identifier of the invoked recommendation algorithm are displayed on a display apparatus of the computer device or a second terminal.

In an example, the execution subject of the recommendation method used in this example (for example, the server 105 shown in FIG. 1) displays user information and the algorithm identifier of the invoked recommendation algorithm on the display apparatus of the computer device or sends it to the second terminal (for example, the electronic device of the operator) through the network. It is understandable that it is also possible to directly set a display apparatus on the execution subject of the recommendation method used in this example (for example, the server 105 shown in FIG. 1) for direct local display. The user information includes user attribute information (such as the user's name, gender, age, etc.), user behavior information (such as clicking, purchasing, browsing, forwarding, sharing, and other operations and commodity information) and prediction information (such as purchase intention). In addition, the algorithm identifier may be, for example, a virtual key on the display interface of the second terminal or the display apparatus of the computer device.

In an example, the execution subject of the recommendation method used in this example (for example, the server 105 shown in FIG. 1) may establish user portraits of a multi-dimensional system in advance. The user portraits mainly include explicit portraits and hidden portraits. The explicit portraits mainly include information that is easy to obtain or can be obtained through simple statistical analysis, such as the user's gender, age, browsing times, purchase frequency and other information. The hidden portraits mainly include user information obtained through in-depth analysis and mining of the user's historical behavior, such as the demand predicting analysis result based on the user's timeline search data, the label system based on the corresponding commodity or service, and the user preference analysis result based on user history behavior, or the like.

In an example, the user portrait of the multi-dimensional system can be visually presented through a visual display interface (for example, a data dashboard). By classifying the explicit portrait and the hidden portrait in the above-mentioned user portrait, the corresponding pluggable display modules can be customized respectively, the visualization presentation may be conducted by operating the corresponding modules. This example is provided with the user portrait main interface and the optional pane of the visualization function module, and the specific display logic is as follows.

1. The user's basic information, such as user's head profile, name, gender, age, location, etc., is displayed in the form of a list on the main interface of the user portrait.

2. In the optional pane of the visualization function module, the information modules (such as hidden portraits) obtained by the server through statistical analysis and mining prediction are displayed, including but not limited to the user operation behavior distribution description module, the user preference analysis module based on the item label system and the user demand prediction module based on user timeline search data.

In the example, the user operation behavior distribution description module mainly performs statistical analysis on the user behavior data, displays the user's login frequency, click frequency, purchase frequency, forward frequency, sharing frequency, function module usage frequency, and average staying time of the function module, or the like through such as line graphs or bar graphs.

The user preference analysis module based on the item label system mainly conducts in-depth mining and analysis on the user's historical behavior log, and displays the user's preference ranking list for the preset label category through such as line graphs or bar graphs. The label may be a label preset for commodity or service, such as “skin care”, “cream”, “new style”, “Internet celebrity” and so on.

The user demand prediction module based on user timeline search data combines the user's historical search content and historical purchase of commodity or service, uses natural language processing technology to analyze the user's historical search content and match it with the preset label content, uses association rule mining technology to predict the commodity or service that users may purchase in the future, and explores users' purchase intention.

This example displays the user portrait from the perspective of the operator based on the user multi-dimensional portrait such as the user portrait main interface and the optional pane of the visualization function module as described above. For example, it is displayed in the form of a radar chart. The dimension of the radar chart includes, but not limited to, user purchasing power based on the user's historical purchase behavior, user purchase potential based on the prediction of user's future purchase behavior, user credibility based on user's historical transaction and return records, or the like.

S204, in response to an operation on the algorithm identifier, first recommendation result information calculated by a corresponding recommendation algorithm is displayed on the display apparatus of the computer device or the second terminal.

In an example, the first recommendation result information may include the ranking of commodities with different recommendation probabilities calculated according to the recommendation algorithm and corresponding commodity information, or the like. In an example, the operator clicks the virtual button corresponding to the algorithm identifier on the second terminal or the display apparatus of the computer device, the execution subject of the recommendation method of this example (for example, the server 105 shown in FIG. 1) responds and displays the first recommendation result information calculated by the recommendation algorithm on the display apparatus of the computer device or the second terminal.

By displaying the user information and the algorithm identifier of the invoked recommendation algorithm on the display apparatus of the computer device or the second terminal, the operator can track the intermediate processes and intermediate results of the recommendation method, i.e., the adopted recommendation algorithm and first recommendation result information, and the recommendation results can also be traced based on a plurality of intermediate results in the execution process, which helps to provide recommendation explanations for the recommendation results, and facilitates the operator to analyze the method more macroscopically, and improve and modify the recommendation method in time.

In an example, step S202 may specifically include:

determining a user type, an application scenario and a recommendation strategy sequentially in response to the user operation data, and invoking at least one recommendation algorithm according to the recommendation strategy to calculate at least one first recommendation result.

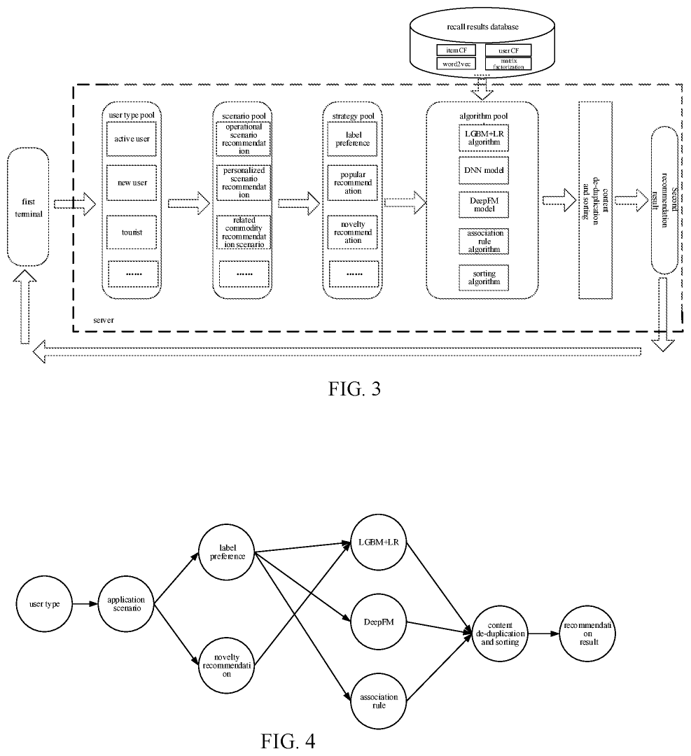

In an example, user types include active users, new users, tourists, etc.; application scenarios include operation recommendation scenarios, personalized recommendation scenarios, and related commodity or service recommendation scenarios, and recommendation strategies include preferences strategies of labels corresponding to the commodity or service, popular recommendation strategies, novelty recommendation strategies, or the like. Taking FIGS. 3-4 as an example, the execution subject of the recommendation method used in this example (for example, the server 105 shown in FIG. 1) responds to a user clicking certain commodity, and determines that the user type is an “active user”. The application scenario of the commodity clicked by the user is a “personalized recommendation scenario”. The server 105 invokes the recommendation algorithm (for example, LGBM+LR algorithm, DeepFM model and association rule algorithm) corresponding to the recommendation strategy according to the recommendation strategies of the “preference strategy of the label corresponding to the commodity or service” and “novelty recommendation strategy” for calculation, to obtain three first recommendation results.

In an example, the recommendation method further includes:

displaying a type identifier of the determined user type, a scenario identifier of the determined application scenario and a strategy identifier of the determined recommendation strategy on the display apparatus of the computer device or the second terminal;

displaying corresponding user type information, application scenario information or recommendation strategy information on the display apparatus of the computer device or the second terminal in response to an operation on the type identifier, scenario identifier or strategy identifier.

In the example, the second terminal is, for example, an electronic device of the operator. The type identifier, scenario identifier, and strategy identifier can be, for example, a virtual button on the display interface. In one example, the operator clicks the virtual button corresponding to the type identifier, scenario identifier, or strategy identifier on the display apparatus of the computer device or the second terminal, the execution subject of the recommendation method of this example (for example, the server 105 as shown in FIG. 1) responds and displays the corresponding information. For example, if an operator clicks a virtual button corresponding to the user type identifier, the user type corresponding to the user can be displayed as “active user”.

By displaying the type identifier of the determined user type, the scenario identifier of the determined application scenario and the strategy identifier of the determined recommendation strategy on the display apparatus of the computer device or the second terminal, the operator can clearly understand the intermediate result of the recommendation method, that is, the user's type information, application scenarios, and the recommendation strategy provided by the recommendation method, or the like, so that the operator knows this recommendation is recommended for whom, in what scenario, and how to recommend, which clearly and intuitively shows different attributes and preferences of different users, provides recommendation reasons for the first recommendation result, thus facilitating comprehensive analysis by the operator.

In an example, the recommendation method further includes:

S205, performing de-duplication and sorting processing on the at least one first recommendation result, to generate a second recommendation result.

In this example, the execution subject of the recommendation method used in this example (for example, the server 105 shown in FIG. 1) performs de-duplication and sorting processing on a plurality of first recommendation results calculated by a plurality of recommendation algorithms. For example, the same commodity or service calculated by different recommendation algorithms is de-duplicated, and then the plurality of first recommendation results after de-duplication are sorted, so as to obtain the second recommendation result. In another example, by setting corresponding weights for all recommendation algorithms, and performing de-duplication and sorting processing on the first recommendation results calculated by recommendation algorithms with different weights, the second recommendation result is obtained. In this example, the second recommendation result can be adjusted by adjusting the weights corresponding to different recommendation algorithms in real time according to the operating conditions of the recommendation method, thereby improving the accuracy of the recommendation method.

In an example, the recommendation method further includes:

S206, displaying a processing identifier of the de-duplication and sorting processing on the display apparatus of the computer device or the second terminal, wherein the processing identifier may be, for example, a virtual button on the display interface of the second terminal or the display apparatus of the computer device;

S207, displaying de-duplication and sorting processing information on the display apparatus of the computer device or the second terminal in response to an operation on the processing identifier, wherein the operation in response to the processing identifier may be, for example, clicking the virtual button corresponding to the processing identifier on the second terminal or the display apparatus of the computer device; in addition, the de-duplication and sorting processing information may include de-duplicated commodity or service information and its corresponding recommendation probability, the ranking of each commodity or service in the first recommendation results corresponding to different recommendation algorithms.

By displaying the processing identifier of the de-duplication and sorting processing on the display apparatus of the computer device or the second terminal, the operator can clearly understand the commodity de-duplicated by the recommendation method and the detailed process of the de-duplication and sorting, that is, understand the process of de-duplication and sorting of the recommendation method, which further provides recommendation explanation for the second recommendation result.

In an example, the recommendation method further includes:

S208, displaying a result identifier of the second recommendation result on the display apparatus of the computer device or the second terminal, wherein the result identifier may be, for example, a virtual button on the display interface of the second terminal or the display apparatus of the computer device;

S209, displaying second recommendation result information on the display apparatus of the computer device or the second terminal in response to an operation on the result identifier, wherein the second recommendation result information may include commodities and related information ranked in a descending order of the recommendation probability, and the recommendation probability corresponding to the commodity.

By displaying the intermediate result, the first recommendation result and the second recommendation result on the display apparatus of the computer device or the second terminal, the operator can clearly and intuitively understand the execution process of the recommendation method from beginning to end, which is convenient for the operator to analyze the method more macroscopically, and improve and modify the recommendation method in time.

In an example, the recommendation method further includes following steps.

S210, a second recommendation result is sent to the first terminal.

In this example, the execution subject of the recommendation method used in this example (for example, the server 105 shown in FIG. 1) sends the second recommendation result to the first terminal (such as the user's electronic device) through the network, so that the user clearly understands the second recommendation result actually recommended by this recommendation method.

S211, user feedback information from the first terminal is acquired, a contribution degree of the recommendation strategy is calculated according to the user feedback information, and the contribution degree is displayed on the display apparatus of the computer device or the second terminal.

In this example, the user provides feedback according to the second recommendation result sent by the server. For example, the user clicks the virtual button of “interested” or “not interested” displayed on the first terminal, the execution subject of the recommendation method used in this example (for example, the server 105 shown in FIG. 1) records the feedback mark fed back by the user at the corresponding second recommendation result according to the positive or negative feedback generated by the user on the second recommendation result, and it is displayed on the display interface of the second terminal or the display apparatus of the second terminal at the same time. In addition, statistical analysis is performed on the collected user feedback data, and the contribution degree of the recommendation strategy corresponding to the second recommendation result to the recommendation method is evaluated from a plurality of dimensions such as different time periods and different user groups. The formula for calculating the contribution degree of the recommendation strategy is as follows:

$${C}_{tb} = \frac{{T}_{pi}}{{\sum }_{N} {T}_{pi}} \times 100 \% ;$$

wherein, C_{tb} represents the contribution degree of the recommendation strategy, Tₚᵢ represents the number of results that the user generates positive feedback, i.e., the second recommendation result calculated using the recommendation strategy i being accepted by the user, and N represents the total number of recommendation strategies.

This example analyzes the contribution degree of different recommendation strategies to this recommendation method, which is convenient for the operator to flexibly adjust different recommendation strategies. The developers can tune the recommendation algorithm in time, which is beneficial to subsequent optimization and iteration of the recommendation algorithms.

Taking the example shown in FIGS. 3-4 as an example, it is started from the interaction triggering between the user and the server 105. The execution subject of the recommendation method used in this example (for example, the server 105 shown in FIG. 1) first constructs an interactive user portrait and is visually presented. At least one corresponding recall algorithm is invoked offline for the user's historical behavior data through the recall result database, to perform offline calculation, so as to obtain different offline calculation results, and the different offline calculation results are saved in the recall result database. Subsequently, in response to a user's operation (clicking, forwarding, sharing) certain commodity or service, the user type (such as active users, new users, and tourists) and the application scenarios of the commodity clicked by the user (such as operation recommendation, personalized recommendation, and related item recommendation) are determined, so as to obtain the recommendation strategy corresponding to the user type in the application scenario, and then the recommendation algorithm corresponding to the recommendation strategy is invoked for calculation to obtain a plurality of first recommendation results. The plurality of first recommendation results is de-duplicated and sorted, to obtain a second recommendation result, and the second recommendation result is sent to the first terminal (such as a user's electronic device), and the user information in the recommendation method, the algorithm identifier, type identifier, scenario identifier, strategy identifier, processing identifier and result identifier of the invoked recommendation algorithm are displayed on the display apparatus of the computer device or the second terminal.

The recommendation method of this example is aimed at a recommendation method triggered by a user's operation. Specifically, the recommendation is for whom, what method is used for recommendation, how to recommend, what the recommendation result is, what the intermediate result is, or the like are all visually presented, which implements systematized and visualized recommendation processes of the recommendation method, completes the tracking of the intermediate processes and intermediate results of the recommendation method, which can clearly and intuitively show the different attributes and preferences of different users, while tracking the execution process of the recommendation method and analyzing the performance of the recommendation method, convenient for operators to analyze the method more macroscopically, and improve and revise it in time. In addition, the recommendation method can also trace the recommendation results based on a plurality of intermediate results in the execution process. Based on the information such as scenario triggers, algorithm triggers, and user feedback obtained from the result traceability, it is helpful to discover user preference scenarios and discover recommendation algorithm module with high efficiency, which helps to optimize the diversity and accuracy of the recommendation system, helps provide the recommendation explanation of the recommendation result, and measures the contribution degree of different recommendation strategies, conducive to the ABTest assessment of performance of the recommendation method and operational content decision. Furthermore, by tracing the source of the second recommendation result and providing related recommendation reasons for the second recommendation result, the interpretability of the recommendation method is enhanced. This recommendation method not only visually reflects the execution process of the recommendation method, but also provides effective data support, which helps to discover application scenarios and recommendation algorithms with high efficiency, and optimize the diversity and accuracy of recommendation methods.

In an example, as shown in FIG. 4, the display apparatus of the computer device or the second terminal displays the above-mentioned identifiers in the form of a directed acyclic graph. The above identifiers are user information, algorithm identifier, user type identifier, scenario identifier, strategy identifier, processing identifier, and result identifier. In graph theory, a directed graph, when starting from a certain vertex, cannot return to the point through several edges, it is called a directed acyclic graph.

Aiming at the execution process of the above-mentioned actual recommendation method, the recommendation method is abstracted as modules to generate a directed acyclic graph. FIG. 4 is a schematic diagram of the directed acyclic graph of the recommendation method for a certain user. There are two stages, specifically as follows.

1) Module abstract encapsulation: for example, user types and application scenarios are abstracted and encapsulated into user type modules and application scenario modules, and different recommendation strategies and different recommendation algorithms are encapsulated into different recommendation strategy modules and different recommendation algorithm modules.

Before abstracting and encapsulating different modules, the following information is retained for different modules.

a) Assign a unique event node ID to each abstraction encapsulation module respectively. For example, an identifier code 01 is configured for the user type module, and a set of event node IDs of a previous stage and a set of event node IDs of a next stage are retained at the same time. That is, a single module can perceive a set of event node IDs of modules of a previous stage and a set of event node IDs of modules of a next stage.

b) Reserve the key information output of the module for each abstraction module. That is, in response to the operation on the module, the key information output of the module can be displayed in real time. For example, the user type result is retained in the user type module, and the user's application scenario set is retained in the scenario determination module, the recommendation strategy set of this recommendation method is retained in each recommendation strategy module, and the ranking result is retained in each recommendation algorithm module, that is, the intermediate result is retained. The above-mentioned intermediate results are packed and put into the second recommendation result set, as the birth source of the second recommendation result and the recommendation explanation, for reference by the operator.

2) Dynamically construct a directed acyclic graph: according to the execution order of the recommendation method, a directed acyclic graph is constructed through the chain-finger relationship of the unique event node ID corresponding to each abstraction encapsulation module, so as to record the actual implementation of the recommendation method.

In an example, the recommendation method is visually displayed on the display apparatus of the computer device or the second terminal in response to the second recommendation result generated by a single operation of a certain user. The user information in the recommendation method, the algorithm identifier, type identifier, scenario identifier, strategy identifier, processing identifier, and result identifier of the invoked recommendation algorithm are displayed through the directed acyclic graph, and the final recommendation result list is displayed, which specifically includes the following.

1) Display content of a directed acyclic graph

a) Legend of the directed acyclic graph: the display apparatus of the computer device or the display interface of the second terminal displays the directed acyclic graph legend of the execution process of the recommendation method generated by the operation of the user, so as to present the name information of the unique event node ID of each abstraction module in the recommendation process, and the execution sequence.

b) The event node output data: buttons are designed for the nodes of the directed acyclic graph of different abstraction modules, so as to control the display of the key information output by the node. It is a non-display state by default. For example, corresponding virtual buttons are set in each recommendation algorithm module. The operator can click different virtual buttons to trigger the operation of connecting to the database to find the key information of the corresponding module, so that the page pops up the key information of the module corresponding to the virtual button. It is understandable that when the key information of each module is empty, the empty data alarm is prompted.

2) The display content of the second recommendation result list includes the follows.

a) The birth situation and recommendation explanation of the recommendation results: as for the second recommendation results, for each intermediate result (i.e., the first recommendation result, user type, recommendation strategy, recommendation algorithm, application scenario, etc.), the birth situation of the second recommendation result is displayed. That is, the application scenario generated by the second recommendation result and the source of the recommendation algorithm are traced, and an explanation of the second recommendation result is generated based on this. For example, the second recommendation result is generated by item similarity, popularity, or friend's likes.

b) User feedback mark: according to the positive feedback or negative feedback generated by the user on the second recommendation result, the user feedback mark is recorded in the corresponding second recommendation result, and displayed on the display apparatus of the computer device or the display interface of the second terminal simultaneously.

c) Analysis of the contribution degree of the recommendation strategy: through the above collection, statistics and analysis of the positive feedback or negative feedback generated by the user for the second recommendation result, the contribution degree of the recommendation strategy to the recommendation method can be evaluated from a plurality of dimensions, such as different time periods and different user groups, and the calculation formula of the contribution degree of the recommendation strategy is as follows:

$${C}_{tb} = \frac{{T}_{pi}}{{\sum }_{N} {T}_{pi}} \times 100 \% ;$$

wherein, C_{tb} represents the contribution degree of the recommendation strategy, Tₚᵢ represents the number of results that the user generates positive feedback, i.e., the second recommendation result calculated using the recommendation strategy i being accepted by the user, and N represents the total number of recommendation strategies.

In this example, by constructing a directed acyclic graph, the execution paths of different modules in the recommendation method can be effectively tracked, and the key intermediate results in the different modules are retained, thereby realizing effective monitoring of the recommendation method.

In an example, in response to the user's multiple operation data, the recommendation method can display multiple second recommendation results on the visual interface, and at the same time a threshold for the number of displayed information is set on the visual interface, for example, only the second recommendation result information of the most recent 10 operations is displayed. At the same time, with respect to the user's historical behavior data, a historical operation recommendation button can also be set to retrieve the corresponding second recommendation result information in the database, for display of the instant query result, which is convenient for the operator to analyze the performance of the recommendation method more macroscopically.

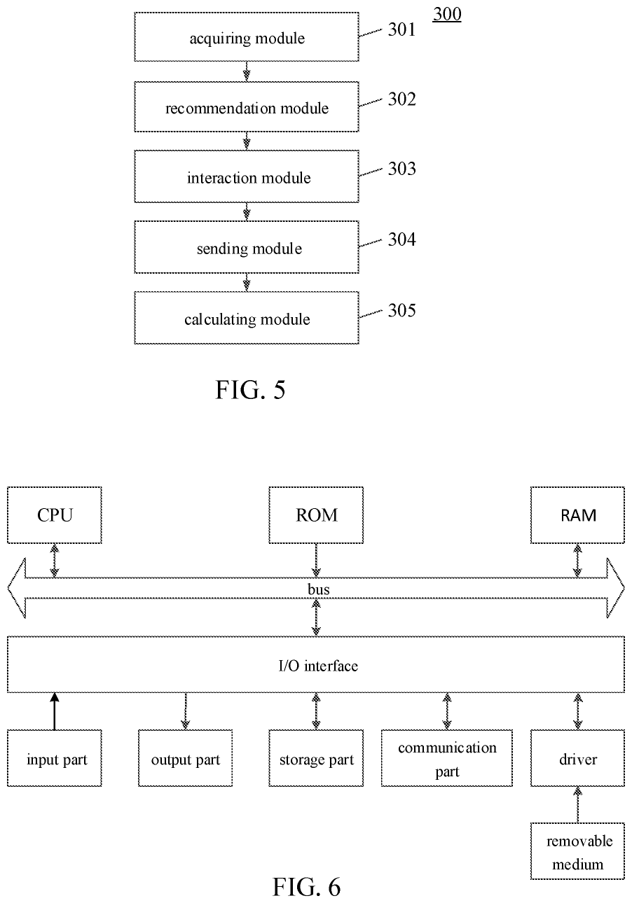

Please refer to FIG. 5, as an implementation of the recommendation method shown in FIG. 2. Another example of the present disclosure provides a computer device 300. The example of the computer device 300 corresponds to the recommendation method example shown in FIG. 2. The computer device 300 can be specifically applied to a server. The computer device 300 includes an acquiring module 301, configured to acquire user operation data from a first terminal; a recommendation module 302, configured to invoke at least one recommendation algorithm in response to the user operation data to calculate at least one first recommendation result; an interaction module 303, configured to display user information and an algorithm identifier of the invoked recommendation algorithm on a display apparatus of the computer device 300 or a second terminal, and display first recommendation result information calculated by a corresponding recommendation algorithm on the display apparatus of the computer device 300 or the second terminal in response to an operation on the algorithm identifier.

In an example, the recommendation module 302 is further configured to: determine a user type, an application scenario and a recommendation strategy sequentially in response to the user operation data, and invoke at least one recommendation algorithm according to the recommendation strategy to calculate at least one first recommendation result.

In an example, the interaction module 303 is further configured to: display a type identifier of the determined user type, a scenario identifier of the determined application scenario and a strategy identifier of the determined recommendation strategy on the display apparatus of the computer device 300 or the second terminal; display corresponding user type information, application scenario information or recommendation strategy information on the display apparatus of the computer device 300 or the second terminal in response to an operation on the type identifier, scenario identifier or strategy identifier.

In an example, the recommendation module 302 is further configured to perform de-duplication and sorting processing on the at least one first recommendation result, to generate a second recommendation result.

In an example, the interaction module 303 is further configured to: display a processing identifier of the de-duplication and sorting processing on the display apparatus of the computer device 300 or the second terminal; display de-duplication and sorting processing information on the display apparatus of the computer device 300 or the second terminal in response to an operation on the processing identifier.

In an example, the interaction module 303 is further configured to: display a result identifier of the second recommendation result on the display apparatus of the computer device 300 or the second terminal; display second recommendation result information on the display apparatus of the computer device 300 or the second terminal in response to an operation on the result identifier.

In an example, the computer device 300 further includes a sending module 304 and a calculating module 305, wherein the sending module 304 is configured to send a second recommendation result to the first terminal; the acquiring module 301 is further configured to acquire user feedback information from the first terminal; the calculating module 305 is configured to calculate a contribution degree of the recommendation strategy according to the user feedback information; the interaction module 303 is further configured to display the contribution degree of the recommendation strategy on the display apparatus of the computer device or the second terminal.

It should be noted that the principle and work flow of the computer device provided in this example are similar to the above-mentioned recommendation method, and the relevant parts can be referred to the above-mentioned description, which will not be repeated herein.

The beneficial effects of this application are as follows:

In view of the current existing problems, this application provides a recommendation method, a computing device and a storage medium. The recommendation method completes the tracking of intermediate processes and intermediate results of the recommendation method by realizing the systemization and visualization of the recommendation processes of the recommendation method, which can clearly and intuitively display different attributes and preferences of different users, and at the same time track the execution process of the recommendation method and analyze the performance of the recommendation method, so that the operator can analyze the method more macroscopically, and improve and modify the recommendation method in time. In addition, the recommendation method can also trace the recommendation results based on a plurality of intermediate results in the execution process, which helps to provide recommendation explanations for the recommendation results, and at the same time measures the contribution degree of different recommendation strategies, conducive to the ABTest assessment of performance of the recommendation method and operational content decision.

As shown in FIG. 6, a computer system suitable for implementing the recommendation method provided by the above-mentioned examples includes a central processing module (CPU), which can perform various appropriate actions and processing according to a program stored in a read-only memory (ROM) or a program loaded from a storage part to the Random access memory (RAM). In RAM, various programs and data required for the operation of the computer system are also stored. CPU, ROM and RAM are connected by this bus. The input/input (I/O) interface is also connected to the bus.

The following components are connected to the I/O interface: the input part including the keyboard, mouse, etc.; the output part including the liquid crystal display (LCD) and the speaker, etc.; the storage part including the hard disk, etc.; and the communication part including the network interface card such as the LAN card, modem, or the like. The communication part performs communication processing via a network such as the Internet. The driver is also connected to the I/O interface as needed. The removable media, such as magnetic disks, optical disks, magneto-optical disks, semiconductor memories, etc., are installed on the driver as needed, so that the computer program read from it can be installed into the storage part as needed.

In particular, according to this example, the process described in the above flowchart can be implemented as a computer software program. For example, this example includes a computer program product, which includes a computer program tangibly contained on a computer-readable medium, and the foregoing computer program includes program codes for executing the method shown in the flowchart. In such an example, the computer program may be downloaded and installed from the network through the communication part, and/or installed from the removable medium.

The flowcharts and schematic diagrams in the accompanying drawings illustrate the possible architecture, functions, and operations of the system, method, and computer program product of this example. In this regard, each block in the flowchart or schematic diagram can represent a module, program segment, or part of the codes, and the above-mentioned module, program segment, or part of the codes contains one or more executable instructions for realizing the specified logic functions. It should also be noted that, in some alternative implementations, the functions marked in the block may also occur in a different order from the order marked in the drawings. For example, two blocks shown in succession can actually be executed substantially in parallel, and they can sometimes be executed in the reverse order, depending on the functions involved. It should also be noted that each block in the schematic and/or flowchart, and the combination of the blocks in the schematic and/or flowchart, can be implemented by a dedicated hardware-based system that performs the specified functions or operations, or it can be implemented by a combination of dedicated hardware and computer instructions.

As another aspect, this example also provides a non-volatile computer storage medium. The non-volatile computer storage medium may be the non-volatile computer storage medium included in the above-mentioned apparatus in the above-mentioned example, and it may also be a non-volatile computer storage medium that exists alone and is not assembled into the terminal. The foregoing non-volatile computer storage medium stores one or more computer programs. When the foregoing one or more computer programs are executed by a processor, the foregoing device can implement the recommendation method described in the example shown in FIG. 2.

The present disclosure may include dedicated hardware implementations such as application specific integrated circuits, programmable logic arrays and other hardware devices. The hardware implementations can be constructed to implement one or more of the methods described herein. Examples that may include the apparatus and systems of various implementations can broadly include a variety of electronic and computing systems. One or more examples described herein may implement functions using two or more specific interconnected hardware modules or devices with related control and data signals that can be communicated between and through the modules, or as portions of an application-specific integrated circuit. Accordingly, the system disclosed may encompass software, firmware, and hardware implementations. The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. The module refers herein may include one or more circuit with or without stored code or instructions. The module or circuit may include one or more components that are connected.

The above-mentioned examples of this application are merely examples to clearly illustrate this application, and are not meant to limit the implementation of this application. For those of ordinary skill in the art, other changes or variations in different forms can also be made on the basis of the above description. The implementations cannot be exhaustively listed herein. Any obvious changes or variations derived from the technical solutions of this application are still within the protection scope of this application.

What is claimed is:

1. A computer device, comprising:
a processor; and
a memory for storing processor executable instructions,
wherein the processor is configured to:
acquire user operation data from a first terminal;
invoke at least one recommendation algorithm in response to the user operation data to calculate at least one first recommendation result;
display an algorithm identifier of the invoked recommendation algorithm on a display apparatus of the computer device or a second terminal, and display first recommendation result information calculated by a corresponding recommendation algorithm on the display apparatus of the computer device or the second terminal in response to an operation on the algorithm identifier.

2. The computer device according to claim 1, wherein the processor is further configured to: determine a user type, an application scenario and a recommendation strategy sequentially in response to the user operation data, and invoke at least one recommendation algorithm according to the recommendation strategy to calculate at least one first recommendation result.

3. The computer device according to claim 2, wherein the processor is further configured to: display a type identifier of the determined user type, a scenario identifier of the determined application scenario and a strategy identifier of the determined recommendation strategy on the display apparatus of the computer device or the second terminal; display corresponding user type information, application scenario information or recommendation strategy information on the display apparatus of the computer device or the second terminal in response to an operation on the type identifier, scenario identifier or strategy identifier.

4. The computer device according to claim 2, wherein the processor is further configured to perform de-duplication and sorting processing on the at least one first recommendation result, to generate a second recommendation result.

5. The computer device according to claim 4, wherein the processor is further configured to: display a processing identifier of the de-duplication and sorting processing on the display apparatus of the computer device or the second terminal; display de-duplication and sorting processing information on the display apparatus of the computer device or the second terminal in response to an operation on the processing identifier.

6. The computer device according to claim 4, wherein the processor is further configured to: display a result identifier of the second recommendation result on the display apparatus of the computer device or the second terminal; display second recommendation result information on the display apparatus of the computer device or the second terminal in response to an operation on the result identifier.

7. The computer device according to claim 2, wherein the processor is further configured to:
send a second recommendation result to the first terminal;
acquire user feedback information from the first terminal;
calculate a contribution degree of the recommendation strategy according to the user feedback information;
display the contribution degree of the recommendation strategy on the display apparatus of the computer device or the second terminal.

8. A method, applied to a computer device and comprising:
acquiring user operation data from a first terminal;
invoking at least one recommendation algorithm in response to the user operation data to calculate at least one first recommendation result;
displaying an algorithm identifier of the invoked recommendation algorithm on a display apparatus of the computer device or a second terminal;
displaying first recommendation result information calculated by a corresponding recommendation algorithm on the display apparatus of the computer device or the second terminal in response to an operation on the algorithm identifier.

9. The method of claim 8, wherein the invoking at least one recommendation algorithm in response to the user operation data to calculate at least one first recommendation result comprises:
determining a user type, an application scenario and a recommendation strategy sequentially in response to the user operation data, and invoking at least one recommendation algorithm according to the recommendation strategy to calculate at least one first recommendation result.

10. The method according to claim 9, wherein the method further comprises:
displaying a type identifier of the determined user type, a scenario identifier of the determined application scenario and a strategy identifier of the determined recommendation strategy on the display apparatus of the computer device or the second terminal;
displaying corresponding user type information, application scenario information or recommendation strategy information on the display apparatus of the computer device or the second terminal in response to an operation on the type identifier, scenario identifier or strategy identifier.

11. The method according to claim 8, wherein the method further comprises:
performing de-duplication and sorting processing on the at least one first recommendation result, to generate a second recommendation result.

12. The method according to claim 11, wherein the method further comprises:
displaying a processing identifier of the de-duplication and sorting processing on the display apparatus of the computer device or the second terminal;
displaying de-duplication and sorting processing information on the display apparatus of the computer device or the second terminal in response to an operation on the processing identifier.

13. The method according to claim 11, wherein the method further comprises:
displaying a result identifier of the second recommendation result on the display apparatus of the computer device or the second terminal;
displaying second recommendation result information on the display apparatus of the computer device or the second terminal in response to an operation on the result identifier.

14. The method according to claim 9, wherein the method further comprises:
sending a second recommendation result to the first terminal;
acquiring user feedback information from the first terminal, calculating a contribution degree of the recommendation strategy according to the user feedback information, and displaying the contribution degree on the display apparatus of the computer device or the second terminal.

15. A computer-readable storage medium with a computer program stored thereon, wherein the program implements a method when executed by a processor, wherein the method is applied to a computer device and comprises:
acquiring user operation data from a first terminal;
invoking at least one recommendation algorithm in response to the user operation data to calculate at least one first recommendation result;
displaying an algorithm identifier of the invoked recommendation algorithm on a display apparatus of the computer device or a second terminal;
displaying first recommendation result information calculated by a corresponding recommendation algorithm on the display apparatus of the computer device or the second terminal in response to an operation on the algorithm identifier.

16. The computer-readable storage medium according to claim 15, wherein the invoking at least one recommendation algorithm in response to the user operation data to calculate at least one first recommendation result comprises:
determining a user type, an application scenario and a recommendation strategy sequentially in response to the user operation data, and invoking at least one recommendation algorithm according to the recommendation strategy to calculate at least one first recommendation result.

17. The computer-readable storage medium according to claim 16, wherein the program further implements following steps when executed by the processor:
displaying a type identifier of the determined user type, a scenario identifier of the determined application scenario and a strategy identifier of the determined recommendation strategy on the display apparatus of the computer device or the second terminal;
displaying corresponding user type information, application scenario information or recommendation strategy information on the display apparatus of the computer device or the second terminal in response to an operation on the type identifier, scenario identifier or strategy identifier.

18. The computer-readable storage medium according to claim 15, wherein the program further implements a following step when executed by the processor:
performing de-duplication and sorting processing on the at least one first recommendation result, to generate a second recommendation result.

19. The computer-readable storage medium according to claim 18, wherein the program further implements following steps when executed by the processor:
displaying a processing identifier of the de-duplication and sorting processing on the display apparatus of the computer device or the second terminal;
displaying de-duplication and sorting processing information on the display apparatus of the computer device or the second terminal in response to an operation on the processing identifier.

20. The computer-readable storage medium according to claim 18, wherein the program further implements following steps when executed by the processor:
displaying a result identifier of the second recommendation result on the display apparatus of the computer device or the second terminal;
displaying second recommendation result information on the display apparatus of the computer device or the second terminal in response to an operation on the result identifier.
